(19) United States
(12) Patent Application Publication
(10) Pub. No.: US 2023/0407072 A1
(43) Pub. Date: Dec. 21, 2023

(54) POLYPROPYLENE COMPOSITION WITH IMPROVED STRESS WHITENING PERFORMANCE

(71) Applicant: SABIC GLOBAL TECHNOLOGIES B.V., BERGEN OP ZOOM (NL)

(72) Inventors: Ting Huang, Shanghai (CN); Chaodong Jiang, Shanghai (CN); Yang Yang, Shanghai (CN); Hongtao Shi, Shanghai (CN); Xin Kong, Shanghai (CN); Christelle Marie Hélène Grein, Aachen (DE); Chunfa Li, Shanghai (CN)

(21) Appl. No.: 18/265,518

(22) PCT Filed: Dec. 6, 2021
(86) PCT No.: PCT/EP2021/084318

§ 371 Date: Jun. 6, 2023

(30) Foreign Application Priority Data
Dec. 7, 2020 (WO) PCT/CN2020/134247

(51) Int. Cl. C08L 23/12; C08L 23/08; B29C 45/00

(52) U.S. Cl. CPC C08L 23/12; C08L 23/0815; B29C 45/0001; C08L 2205/025; C08L 2205/03; C08L 2203/20; B29K 2023/12

(57) ABSTRACT

A polypropylene composition includes (A) a polypropylene, (B1) a first copolymer of ethylene and α-olefin having a density of 0.891 to 0.912 g/cm³, and (B2) a second copolymer of ethylene and α-olefin having a density in the range of 0.859 to 0.881 g/cm³, wherein the amount of (A) the polypropylene is in the range from 71 to 87 wt % based on the total amount of the polymer composition, and wherein the ratio between the amount of the (B2) second copolymer of ethylene and α-olefin and the amount of the (B1) first copolymer of ethylene and α-olefin is in the range from 3.8 to 1.0. The polypropylene composition has improved stress whitening resistance. A battery case including the polypropylene composition is also disclosed.

### CROSS REFERENCE TO RELATED APPLICATIONS

This application is a National Stage application of PCT/EP2021/084318, filed Dec. 6, 2021, which claims the benefit of PCT Application No. PCT/CN2020/134247, filed Dec. 7, 2020, both of which are incorporated by reference in their entirety herein.

### BACKGROUND

The present invention relates to a polypropylene composition and the process for the preparation of the polypropylene composition. The present invention also relates to a battery case comprising the polypropylene composition. The present invention further relates to the use of the polypropylene composition in a battery case.

It is know that polypropylene based material can be used automotive as battery case. For example: EP3234008B1 discloses a new injection molded article with improved stress whitening, said article comprises a polypropylene composition based on a heterophasic propylene copolymer and low amounts of inorganic filler. The injection molded articles show a good stiffness/impact balance paired with outstanding stress whitening resistance. The article is preferably a battery case.

There is still further need to improve the stiffness and stress whitening resistance of the material used as battery case.

### SUMMARY

It is the object of the present invention to provide a polymer composition with improved stress whitening resistance while having superior stiffness.

In the context of the present invention, stiffness is quantified by flexural strength as measured according to ASTM D790-17. “superior stiffness” means the flexural strength of the polymer composition is at least 30.0 MPa.

The object of the invention is achieved by a polymer composition comprising (A) a polypropylene, (B1) a first copolymer of ethylene and α-olefin having a density of 0.891 to 0.912 g/cm³ as measured according to ASTM D792-13, (B2) a second copolymer of ethylene and α-olefin having a density in the range of 0.859 to 0.881 as measured according to ASTM D792-13, wherein the amount of (A) the polypropylene is in the range from 71 to 87 wt % based on the total amount of the polymer composition, wherein the ratio between the amount of the (B2) second copolymer of ethylene and α-olefin and the amount of the (B1) first copolymer of ethylene and α-olefin is in the range from 3.8 to 1.0.

The inventor of the present invention surprisingly found the composition according to the invention has improved stress whitening resistance while maintaining sufficient stiffness.

### DETAILED DESCRIPTION

### Polypropylene (A)

The polypropylene (A) according to the invention may be a propylene homopolymer, a propylene random copolymer or a heterophasic propylene copolymer.

Preferably the polypropylene (A) according to the invention is a propylene homopolymer. As a propylene homopolymer is more likely to provide sufficient stiffness to the polymer composition.

The process to produce polypropylene is known in the art. Preferably the polypropylene of the present invention is produced in a sequential polymerization process comprising at least two reactors, more preferably the polypropylene of the present invention is produced in a sequential polymerization process comprising at least three reactors.

The catalyst to produce polypropylene is also know in the art, for example Ziegler-Natta catalyst, metallocene catalyst. Preferably the catalyst used to produce the polypropylene of the present invention is a Ziegler-Natta catalyst which is free of phthalate, for example the catalyst comprises compounds of a transition metal of Group 4 to 6 of IUPAC, a Group 2 metal compound and an internal donor wherein said internal donor is a compound selected from a list consisting of substituted malonates, maleates, succinates, glutarates, cyclohexene-1,2-dicarboxylates, benzoates and derivatives and/or mixtures thereof, preferably the internal donor is a citraconate.

Preferably the polymer in the polymer composition of the present invention is a polypropylene, wherein the melt flow index (MFI) of the polypropylene is in the range from 1.9 to 17.8 dg/min, preferably in the range from 2.3 to 11.2 dg/min, even more preferably in the range from 2.9 to 6.2 dg/min as measured according to ISO 1133-1:2011 at 230° C. under a 2.16 kg load.

### Copolymers of Ethylene and α-Olefin

The composition of the invention comprises (B1) a first copolymer of ethylene and α-olefin and (B2) a second copolymer of ethylene and α-olefin.

The α-olefin comonomer in the (B1) first copolymer of ethylene and α-olefin is preferably derived from the group consisting of 1-butene, 1-hexene and 1-octene, more preferably the α-olefin comonomer in the (B1) first copolymer of ethylene and α-olefin is derived from 1-octene.

The α-olefin comonomer in the (B2) second copolymer of ethylene and α-olefin is preferably derived from the group consisting of 1-butene, 1-hexene and 1-octene, more preferably the α-olefin comonomer in the (B2) second copolymer of ethylene and α-olefin is derived from 1-octene.

The (B1) first copolymer of ethylene and α-olefin has a density in the range of 0.891 to 0.912 g/cm³, preferably in the range of 0.895 to 0.907 g/cm³ as measured according to ASTM D792-13.

The (B2) second copolymer of ethylene and α-olefin has a density in the range of 0.859 to 0.881 g/cm³, preferably in the range of 0.863 to 0.872 g/cm³ as measured according to ASTM D792-13.

Copolymers which are suitable for use in the current invention are commercially available for example under the trademark EXACT™ available from Exxon Chemical Company of Houston, Texas or under the trademark ENGAGE™ polymers, a line of metallocene catalyzed plastomers available from Dow Chemical Company of Midland, Michigan or Cohere™ and Fortify™ from SABIC.

The copolymers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The copolymers may also be prepared using traditional types of heterogeneous multi-sited Ziegler-Natta catalysts.

Preferably the melt flow index (MFI) of (B1) first copolymer of ethylene and α-olefin is in the range from 0.5 to 2.3 dg/min, more preferably in the range from 0.7 to 1.6 dg/min as measured according to ISO 1133-1:2011 at 190° C. under a 2.16 kg load.

Preferably the MFI of (B2) second copolymer of ethylene and α-olefin is in the range from 0.4 to 3.2 dg/min, more preferably in the range from 0.8 to 1.8 dg/min as measured according to ISO 1133-1:2011 at 190° C. under a 2.16 kg load.

Preferably the ratio between the MFI of the (B1) first copolymer of ethylene and α-olefin and the MFI of the (B2) second copolymer of ethylene and α-olefin is in the range from 0.5 to 2.3, preferably in the range from 0.7 to 1.4, wherein the MFI of the (B1) first copolymer of ethylene and α-olefin and the MFI of the (B2) second copolymer of ethylene and α-olefin is measured according to ISO 1133-1:2011 at 190° C. under a 2.16 kg load.

The first copolymer and the second copolymer may be melt-mixed with the other components by adding them as separate components. Alternatively, the first copolymer and the second copolymer may be added as one component after melt-mixing the first copolymer and the second copolymer.

Alternatively, the first copolymer and the second copolymer may be added as one component produced as a bimodal copolymer made by polymerizing the first (or second) copolymer and subsequently polymerizing the second (or first) copolymer in the presence of the first (or second) copolymer. In this case, the first copolymer and the second copolymer may be polymerized in the same reactor or different reactors. It is understood that a bimodal copolymer has a molecular weight distribution having two peaks corresponding to the first median and the second median of the respective stages in the polymerization.

### Polymer Composition

The amount of the (A) polypropylene in the polymer composition is in the range from 71 to 87 wt % based on the total amount of the polymer composition.

The total amount of (B1) the first copolymer of ethylene and α-olefin and (B2) the second copolymer of ethylene and α-olefin is preferably in the range from 15 to 29 wt % based on the total amount of the polymer composition.

The ratio between the amount of the (B2) second copolymer of ethylene and α-olefin and the amount of the (B1) first copolymer of ethylene and α-olefin is in the range from 3.8 to 1.0, preferably in the range from 3.5 to 1.2, even preferably in the range from 2.6 to 1.8.

The MFI of the polymer composition is preferably in the range from 2.8 to 23 g/10 min, more preferably in the range from 3.0 to 9.2 g/10 min as measured according to ISO 1133-1:2011 at 230° C. under a 2.16 kg load.

The polymer composition according to the invention may further additives, e.g. stabilizer, nucleating agent.

The polymer composition can be prepared in a conventional compounding process or by dry blending during an injection moulding process. Preferably the polymer composition is prepared in a compounding process.

In one embodiment of the present invention, the polymer composition comprises at most 3.5 wt % inorganic filler, wherein the inorganic filler may be talc or glass fiber.

The present invention also relates to a battery case, wherein the battery case comprises the polymer composition according to the invention.

Preferably the amount of the polymer composition is at least 95 wt %, more preferably at least 98 wt % based on the total amount of the battery case.

A battery case is an enclosure of battery, wherein preferably the battery is an automotive battery, wherein preferably the battery is a lead acid battery.

The present invention further relates a process for the preparation of a battery case comprising the comprising the following sequential steps:
Preparing the polymer composition of the invention by compounding;
Injection moulding the polymer composition obtained from the previous step into a battery case.

The present invention also relates to the use of the polymer composition according to the invention in a battery case.

### Experiment

### Polypropylene

PP: PP2832E1(1080K) is a propylene homopolymer commercially available from FREP, it has an MFI of 3.4 g/10 min as measured according to ISO 1133-1:2011 at 230° C. under a 2.16 kg load.

### Copolymers of Ethylene and α-Olefin

Copolymers of ethylene and α-olefin as shown in Table 1 were used. The MFI shown below was measured according to ISO 1133-1:2011 at 190° C. under a 2.16 kg load. The density was measured according to ASTM D792-13.

TABLE 1

| Copol- | | | α-olefin | MFI @ | Density |
|---|---|---|---|---|---|
| ymer | Supplier | Grade name | comonomer | 190° C. | (g/cm³) |
| COP1 | SABIC | LLDPE | Butene | 1.0 | 0.918 |
| | | 118NJ | | | |
| COP2 | ExxonMobil | Vistamaxx ™ | Propylene | 1.4 | 0.862 |
| | | 6102 | | | |
| COP3 | SABIC | Cohere ™ | Octene | 1.0 | 0.902 |
| | | 8102 | | | |
| COP4 | SABIC | Fortify ™ | Octene | 1.0 | 0.885 |
| | | C1085 | | | |
| COP5 | SABIC | Fortify ™ | Octene | 1.0 | 0.868 |
| | | C1070D | | | |
| COP6 | LG Chem | Lucene ™ | Butene | 1.1 | 0.870 |
| | | LC175 | | | |

Additive package: The additive package used in the present invention comprise conventional stabilizers for polyolefin. The same type and amount of stabilizers were used in all the examples.

### Specimen Preparation

Pellets of the examples were prepared by compounding the ingredients in a Coperion ZSK 26 twin screw extruder under the following settings:

Zone 1-9 temperature: 50° C.-80° C.-175° C.-175° C.-160° C.-160° C.-160° C.-150° C.-150° C.;

Throughput: 15 kg/h;

Rotation speed: 300 RPM.

Composition of samples are illustrated in Table 2

Then the pellets of examples were provided to an injection molding machine (FANAC S-2000i type) to prepare specimens for the following measurements.

### Measurement

Flexural strength: Flexural strength was measured according to ASTM D790-17. The measurement was taken at 23° C.

Melt flow index (MFI): Measurement on the MFI of the examples was carried out using the pellets of examples obtained after the compound step according to ISO

Stress whitening: Samples were injection moulded into plaques with dimension: 250*250*2 mm. The measurement was taken at 23° C.

The stress whitening test was performed on a customized machine. The customized machine comprises two parts: A weight release mechanism and a plaque support.

The weight release mechanism is able to release a metallic ball with 500 gram weight and 50 mm diameter from a height H1 (in Table 2) with 0 initial velocity as a free falling object to create stress whitening on the test plaque.

The plaque support comprises two square-shape metallic clamps with open space in the centre, the shape of the open space is also square. The outside dimensions of the clamps is 250*250 mm and inside dimension of the clamps is 230*230 mm. The horizontal geometric centre of the outer square superposes with that of the inner square. When a plaque is installed on the plaque support, it is fixed horizontally by compression between the clamps and the horizontal geometric centre of the plaque superposes with that of the clamps.

The weight release mechanism and the plaque support are positioned in a way that the falling weight impact is created perpendicularly on the plaque surface. The horizontal geometric centre of the plaque superposes with that of the impact point.

After the falling impact, the plaque was checked visually whether a whitening part is present on its surface. A rating 1 is given to a plaque without any visible stress whitening, a rating of 0 is given to a plaque with visible stress whitening. 10 plaques were tested for each formulation and the sum of the stress whitening rating for each formulation was calculated.

TABLE 2
Formulation of samples and result of measurement

| | CE1 | CE3 | CE4 | CE5 | CE6 | CE7 | CE8 | EX1 | EX2 | CE9 |
|---|---|---|---|---|---|---|---|---|---|---|
| PP (wt %) | 74.56 | 74.56 | 74.56 | 79.65 | 74.56 | 74.56 | 69.56 | 72.56 | 74.56 | 74.56 |
| COP1 (wt %) | 25 | | | | | | | | | |
| COP2 (wt %) | | | | | 5 | | | | | |
| COP3 (wt %) | | | | | | 5 | 10 | 9 | 8 | |
| COP4 (wt %) | | 25 | | | | | | | | |
| COP5 (wt %) | | | 25 | 20 | 20 | 20 | 20 | 18 | 17 | |
| COP6 (wt %) | | | | | | | | | | 25 |
| Weight ratio COP5/COP3 | | | | | | 4.0 | 2.0 | 2.0 | 2.1 | |
| Additive package (wt %) | 0.44 | 0.44 | 0.44 | 0.44 | 0.44 | 0.44 | 0.44 | 0.44 | 0.44 | 0.44 |
| MFI (g/10 min) | 3.4 | 3.7 | 3.8 | 4.1 | 3.9 | 3.5 | 4.0 | 3.8 | 4.0 | 4.0 |
| Flexural strength (MPa) | 37.3 | 33.1 | 32.5 | 35.6 | 27.2 | 34.0 | 29.0 | 32.3 | 33.1 | 32.1 |
| Stress whitening rating | * | 0 | 0 | 0 | 0 | 5 | 8 | 9 | 10 | 0 |
| H1 = 70 mm | | | | | | | | | | |
| Stress whitening rating | * | 0 | 0 | 0 | 0 | 0 | 0 | 9 | 9 | 0 |
| H1 = 300 mm | | | | | | | | | | |

* Sample broke upon falling impact

To satisfy the requirement for battery case, the stress whitening rating at H1=70 mm and H1=30 mm needs to be at least 8. It is clear from the data that only inventive examples EX1 and EX2 satisfy this requirement.

1. A polymer composition comprising:
(A) a polypropylene,
(B1) a first copolymer of ethylene and α-olefin having a density of 0.891 to 0.912 g/cm³ as measured according to ASTM D792-13, and
(B2) a second copolymer of ethylene and α-olefin having a density in the range of 0.859 to 0.881 g/cm³ as measured according to ASTM D792-13,
wherein the amount of (A) the polypropylene is in the range from 71 to 87 wt % based on the total amount of the polymer composition, and
wherein the ratio between the amount of the (B2) second copolymer of ethylene and α-olefin and the amount of the (B1) first copolymer of ethylene and α-olefin is in the range from 3.8 to 1.0.

2. The polymer composition according to claim 1 wherein the ratio between the amount of the (B2) second copolymer of ethylene and α-olefin and the amount of the (B1) first copolymer of ethylene and α-olefin is in the range from 3.5 to 1.2.

3. The polymer composition according to claim 1 wherein the melt flow index (MFI) of the polypropylene is in the range from 1.9 to 17.8 dg/min, as measured according to ISO 1133-1:2011 at 230° C. under a 2.16 kg load.

4. The polymer composition according to claim 1, wherein the α-olefin comonomer in the (B1) first copolymer of ethylene and α-olefin comonomer is derived from 1-butene, 1-hexene, or 1-octene.

5. The polymer composition according to claim 1, wherein the α-olefin comonomer in the (B2) second copolymer of ethylene and α-olefin comonomer is derived from 1-butene, 1-hexene, or 1-octene.

6. The polymer composition according to claim 1, wherein the (A) polypropylene is a propylene homopolymer.

7. The polymer composition according to claim 1, wherein the ratio between the MFI of the (B1) first copolymer of ethylene and α-olefin and the MFI of the (B2) second copolymer of ethylene and α-olefin is in the range from 0.5 to 2.3, and wherein the MFI of the (B1) first copolymer of ethylene and α-olefin and the MFI of the (B2) second copolymer of ethylene and α-olefin are measured according to ISO 1133-1:2011 at 190° C. under a 2.16 kg load.

8. The polymer composition according to claim 1, wherein the MFI of (B1) first copolymer of ethylene and α-olefin is in the range from 0.5 to 2.3 dg/min, as measured according to ISO 1133-1:2011 at 190° C. under a 2.16 kg load.

9. The polymer composition according to claim 1, wherein the MFI of (B2) second copolymer of ethylene and α-olefin is in the range from 0.4 to 3.2 dg/min, as measured according to ISO 1133-1:2011 at 190° C. under a 2.16 kg load.

10. The polymer composition according to claim 1, wherein the MFI of the polymer composition is in the range from 2.8 to 23 g/10 min, as measured according to ISO 1133-1:2011 at 230° C. under a 2.16 kg load.

11. A battery case comprising the polymer composition of claim 1.

12. A process for the preparation of a battery case comprising the polymer composition of claim 1, the comprising the following sequential steps:
preparing the polymer composition by compounding; and
injection moulding the polymer composition obtained from the previous step into a battery case.

13. (canceled)

14. The polymer composition according to claim 4, wherein the α-olefin comonomer in the (B1) first copolymer of ethylene and α-olefin comonomer is derived from 1-octene.

15. The polymer composition according to claim 5, wherein the α-olefin comonomer in the (B2) second copolymer of ethylene and α-olefin comonomer is derived from 1-octene.
